(19) United States
(12) Patent Application Publication
(10) Pub. No.: US 2017/0043361 A1
(43) Pub. Date: Feb. 16, 2017

(54) CONTINUOUS FLOW INDUSTRIAL PRODUCTS APPLICATOR DEVICE

(71) Applicant: Robert Kerry Smuin, Helena, MT (US)

(72) Inventor: Robert Kerry Smuin, Helena, MT (US)

(21) Appl. No.: 15/233,824

(22) Filed: Aug. 10, 2016

Related U.S. Application Data
(60) Provisional application No. 62/203,590, filed on Aug. 11, 2015.

(51) Int. Cl. B05B 7/00; B05B 12/08; B05B 7/24

(52) U.S. Cl. CPC B05B 7/0093; B05B 7/2491; B05B 12/087

(57) ABSTRACT

The Invention is a spray gun device to apply a coating product: such as paint, stucco, and drywall mud, to any surface using positive air pressure through a material supply line connected to a sealed container holding the coating product, which has a removable pressure lid. The Invention has an air pressure system to provide pressurized compressed air to propel the coating product through the a material supply line to the spray gun, by producing pressurized compressed air through the compressor air hose from the air pressure source, into the interior compartment of the sealed container and to the spray gun. Clamps attaching to the outer side of the removable pressure lid and pressure regulators secure the removable pressure lid to the sealed container and allow for safe and effective use; and a chassis allows for transporting the entire device.

This application claims priority from the provisional patent application filed Aug. 11, 2015, Application No.: 62/203,590, Confirmation Number 5084.

### FIELD OF THE INVENTION

The present invention of this application (“Invention”) relates to spray gun systems for the application of liquid and viscous solid texture and other products, such as paint, stucco and other coatings.

### BACKGROUND

There is a need to create a way to apply and use paint and texture products such as stucco, drywall mud and brown coating with any universal spray gun using positive air pressure, to apply these coating products to a surface.

The closest technology available at this time in the related art would be the hopper gun/spray paint system or device, using a jet vacuum, which is in direct opposition to the positive air pressure system of the present Invention that creates the continuous flow of product to be applied to the surface. There is no technology that functions on the structure and method of the Invention where used for the purpose set forth herein or in this industry.

Old established systems in related art, specifically the hopper and the jet systems, “pull materials out” via a vacuum mechanism. A positive air pressure system such as the Invention would make the process superior to the “negative” air pressure systems and devices in many ways. The potential application of the present Invention is open to any form of spraying paint or textured material to complete any coating project. The standard industry using this Invention would be commercial, private, and any construction projects, but its use could extend into any field desiring to spray paint and/or texture materials such as artwork, finishing wooden objects with paint, varnish or other similar product, including for spray finishes on metal objects such as custom vehicles. The uses of the invention are open to the imagination and could be considered limitless for coating projects.

Current technology is encountering difficulty with retaining air pressure in a bucket or container in current coating applicator systems or devices without using some clamp elements. Commonly used wood lid clamping systems fail—leak, and cause the clamps to “blow off” when the applicator system is supplied with too much pressure, due to the weak wood construction of the clamps. The Invention provides a metal safety crossbar element for clamping strong enough to withstand the required pounds per square inch (psi) of air pressure, up to 90 psi, with no leakage or pop off as with wood clamps. A problem encountered with current systems in the art is keeping the lid on the bucket while increasing the psi to create a positive air pressure. The Invention is provided with a safety crossbar, such as from re-bar, mounted in such a manner that the bucket or container lid, which bucket is holding the coating product under pressure, ceases any leakage and remains firm and tight on the bucket at all degrees of psi, up to 90+psi. The multiple clamps of the present Invention plus the safety crossbar of the present Invention provide for a safe and proper use of this Invention applicator device and system.

A minimum operating pressure of at least 20 psi is required to operate and spray stucco, drywall mud or other textures to a surface. There is a lack of pressure in the related art due to drag or resistance of the coating products on interior wall surfaces of the containers and on interior supply lines. Shelburne (U.S. Pat. No. 1,710,435) and Beach (U.S. Pat. No. 1,727,500) disclose paint spraying devices in which the coating material product supply lines are too restrictive and too small to handle large volumes of stucco or drywall mud at a rate of speed and pressure required for spraying. The safety valves disclosed in the devices of the related art govern the pressure in order to restrict usage to a safe pressure level, but restrict the pressure to a level too low to what is required to force material up the material feed or supply line to a spray gun for application on a surface.

The device disclosed in Escoto, Jr., et al (U.S. Pat. No. 7,410,102 B2) operates at a low 30 psi, governed by its safety “pop off” valve, and Carlson (U.S. Pat. No. 2,378,184) also operates at a pressure too low to spray a large volume of stucco and drywall mud at a high rate. As well, the spray nozzle disclosed in Escoto, Jr., is too small to handle heavy viscose material such as stucco and drywall mud.

Finally, the container in Escoto, Jr., is too small to have any useful capacity, 50 to 1000 milliliters. Liedberg, et al. (U.S. Pat. No. 3,118,569) and Shelburne (U.S. Pat. No. 1,710,435) operate in the manner of Beach with inadequately low pressure and restrictive material supply lines. All three of these devices (Escoto, Jr.; Liedberg, et al. and Shelburne) operate as paint tools for these reasons and do not operate as stucco or other texture/mud product applicators. The prior art teaches away from the disclosures of the present Invention for higher pressures required for texture/mud product applicators because the pressures required are found too dangerous for normal consumer operation.

None of the references found in the prior art contain every feature of the present Invention, and none of these references in combination disclose or teach every feature of the present Invention.

The foregoing and other objectives, advantages, aspects, and features of the present Invention will be more fully understood and appreciated by those skilled in the art upon consideration of the detailed description of a preferred embodiment, presented below in conjunction with the accompanying drawings.

### SUMMARY OF THE INVENTION

The present Invention is directed to spray gun devices for the application of liquid and viscous solid texture and other products: such as paint, spackling, shotcrete, stucco, drywall mud, brown coating and other coatings. The present invention discloses a device to apply and use paint and texture products such as spackling, shotcrete, stucco, drywall and brown coating with any universal spray gun using positive air pressure. The present Invention, the continuous flow industrial products applicator device, comprises an at least one spray gun; an at least one material supply line cooperatively connected to a sealed container having a removable pressure lid and an interior compartment containing a coating product to be applied to a surface by the at least one spray gun. The coating product includes at least one of paint or a viscous surface coating, including spackling, shotcrete, stucco, and other viscous protective coatings. The at least one spray gun comprises at least one of a paint gun or a texture gun. The material supply line is operatively located within the interior compartment of the sealed container for receiving the coating product.

The Invention also comprises an air pressure system comprising: an air pressure source, an at least one compressor air hose, and an air pressure control means. The air pressure system provides the pressurized compressed air to “positively” push or propel the coating product through the at least one material supply line and the at least one spray gun. The air pressure source is operatively attached to the at least one compressor air hose producing and delivering pressurized compressed air through the at least one compressor air hose from the air pressure source to and through the air pressure control means operatively connected to the at least one compressor air hose. The air pressure control means are operatively connects intermediately, or midway, on and to the at least one compressor air hose between the air pressure source and the at least one spray gun, and between the air pressure source and the sealed container, and functions as a means to control and regulate the pressurized compressed air transmitting from the air pressure source to the at least one spray gun and to the sealed container. Pressurized compressed air is applied from the air pressure source through the at least one compressor air hose into the interior compartment of the sealed container and to the at least one spray gun.

One embodiment of the present Invention also comprises: a plurality of clamping means attaching to the outer side of the removable pressure lid, as a means for sealingly securing said removable pressure lid to the sealed container; and the chassis for mounting and transporting the sealed container, the at least one spray gun, the material supply line, the container air hose, the at least one spray gun air hose and the plurality of clamping means.

The aforementioned features, objectives, aspects and advantages of the present invention, and further objectives and advantages of the invention, will become apparent from a consideration of the drawings and ensuing description.

### BRIEF DESCRIPTION OF THE SEVERAL VIEWS OF THE DRAWINGS

The foregoing features and other aspects of the present invention are explained, and other features and objects of the present invention will become apparent, in the following detailed descriptions, taken in conjunction with the accompanying drawings. However, the drawings are provided for purposes of illustration only, and are not intended as a definition of the limits of the invention.

FIG. 1 illustrates a perspective elevational view of an embodiment of the present Invention and its elements.

FIG. 2 illustrates a perspective elevational view of an alternative embodiment of the present Invention, showing a portion of the present Invention including a plurality of clamping means and at least one spray gun, where the at least one spray gun is depicted as paint guns for use with paint coating products.

FIG. 2A illustrates a partial perspective elevational view of FIG. 2 in an alternative embodiment of the present Invention, having a lightweight removable bucket.

FIG. 3 illustrates a perspective elevational view of an alternative embodiment of the present Invention, showing a portion of the present Invention including at least one spray gun, where the at least one spray gun is depicted as paint guns for use with paint coating products, an air pressure control means and an air pressure source.

FIG. 4 illustrates a perspective elevational view of an alternative embodiment of an at least one spray gun to an embodiment of the present Invention, where the at least one spray gun is depicted as a texture gun for use with texture coating products, including drywall mud, shotcrete, spackling, brown coating, stucco and other viscous surface coatings, as well as a removable pressure lid.

FIG. 5 illustrates a blown up partial, elevated and underside front view of a portion of an embodiment of the present Invention, depicting the inner side of the removable pressure lid and other elements of the present Invention in operable contact with the pressure lid.

FIG. 6 illustrates a perspective view of an embodiment of the present Invention, depicting the chassis, hose hangers, and the safety crossbar clamp.

FIGS. 6A-C illustrate perspective views of the detachable elements to the embodiment of the present Invention depicted in FIG. 6.

FIG. 7 illustrates a top, planar view of an embodiment of the present Invention, depicting the container base, a plurality of hollow clamp legs and a pivoting means.

FIG. 8 illustrates a top, planar view of the present Invention, depicting the outer side of the removable pressure lid and the position of the plurality of clamping means, having screw clamps threaded onto the plurality of hollow clamp legs and tightened down on the removable pressure lid.

### ELEMENT LISTING FOR THE DRAWING FIGURES

The following two pages set forth a legend listing the numbered elements depicted in the aforementioned Figures to embodiments of the present Invention.
90—continuous flow industrial products applicator device
100—air pressure system
101—at least one spray gun

101a—at least one paint gun

101b—texture gun

101c—paint

101d—viscous surface coating
102—at least one material supply line
103—at least one gun end
104—an opposite at least one container end
105—sealed container

105a—large, durable container
106—coating product
107—surface
108—removable pressure lid

108a—outer side

108b—opposing inner side

108c—viscous nipple (material supply line connection)

108d—air intake nipple

108e—lid outer ring

108f—lid inner ring

108g—a plurality of lid notches

108h—lid edge
109—interior compartment (sealed container wall surface)
110—air pressure source
111—pressurized compressed air
112—at least one compressor air hose
113 a plurality of clamping means

113a—safety crossbar clamp

113b—a plurality of hollow clamp legs

113c—threaded screw clamp

113d—threaded clamping end

113e—plurality of crossbar clamp legs

113f—leg fittings

113g—clamp weld

113h—pivoting means

113i—opposite base end
114—source end
115—opposing control end
116—air pressure control means
117—container air hose

117a—pressure regulator end

117b—opposing container valve end
118—at least one spray gun air hose

118a—at least one gun valve end

118b—opposing at least one spray gun air end
119—a plurality of pressure regulators

119a—a plurality of pressure valves
120—plurality of connecting means
121—chassis
122—container base
124—material supply line tee

124a—tee plug
125—air supply tee

125a—pressure release pop-off valve
126—hose hangers
127—gasket lining
128—safety crossbar holder
129—dolly handle
130—pressure regulator bar
131—adjustable wheels and wheel mounts
132—lightweight, removable bucket

### DETAILED DESCRIPTION OF THE INVENTION

The present Invention will now be described more fully hereinafter with references to the accompanying drawings, in which the preferred embodiment of the Invention is shown. This Invention may, however, be embodied in different forms, and should not be construed as limited to the embodiments set forth herein. Rather, the illustrative embodiments are provided so that this disclosure will be thorough and complete, and will fully convey the scope of the Invention to those skilled in the art. It should be noted, and will be appreciated, that numerous variations may be made within the scope of this Invention without departing from the principle of this Invention and without sacrificing its chief advantages. Like numbers refer to like elements throughout.

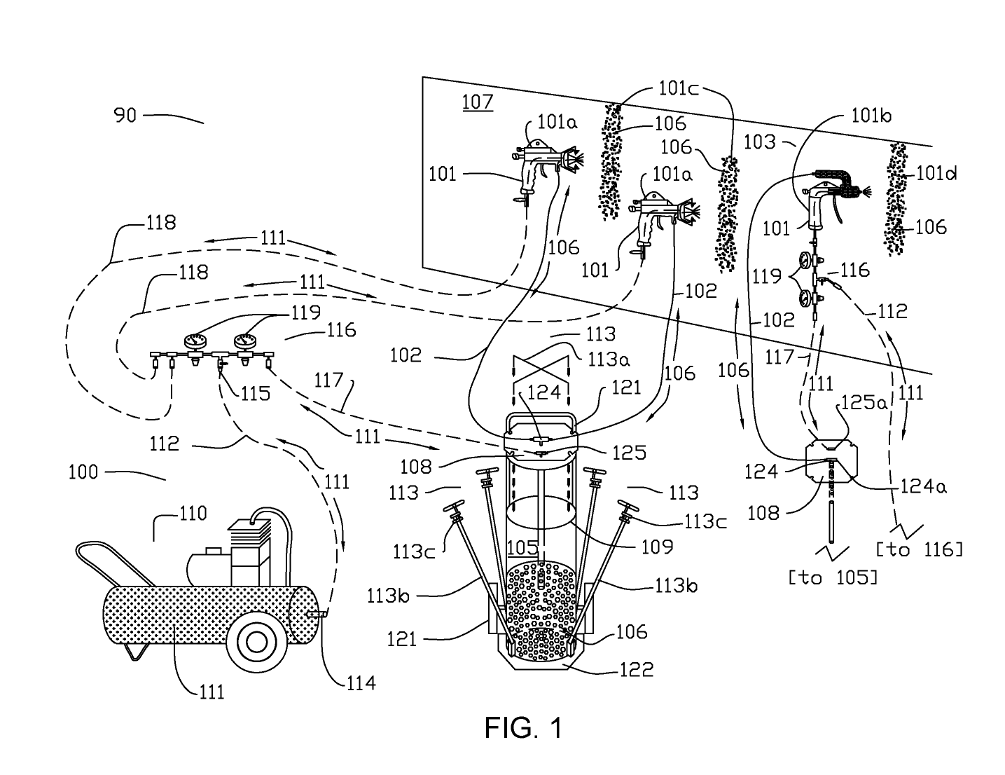

The attached FIG. 1 depicts an embodiment of the present Invention, a continuous flow industrial products applicator device 90, comprising an at least one spray gun 101; an at least one material supply line 102 having an at least one gun end 103 cooperatively connected to the at least one spray gun 101 and an opposite at least one container end 104 cooperatively connected to a sealed container 105. The sealed container 105 has a removable pressure lid 108 and an interior compartment 109, defined by the sealed container 105 interior wall surface, containing a coating product 106 to be applied to a surface 107 by the at least one spray gun 101.

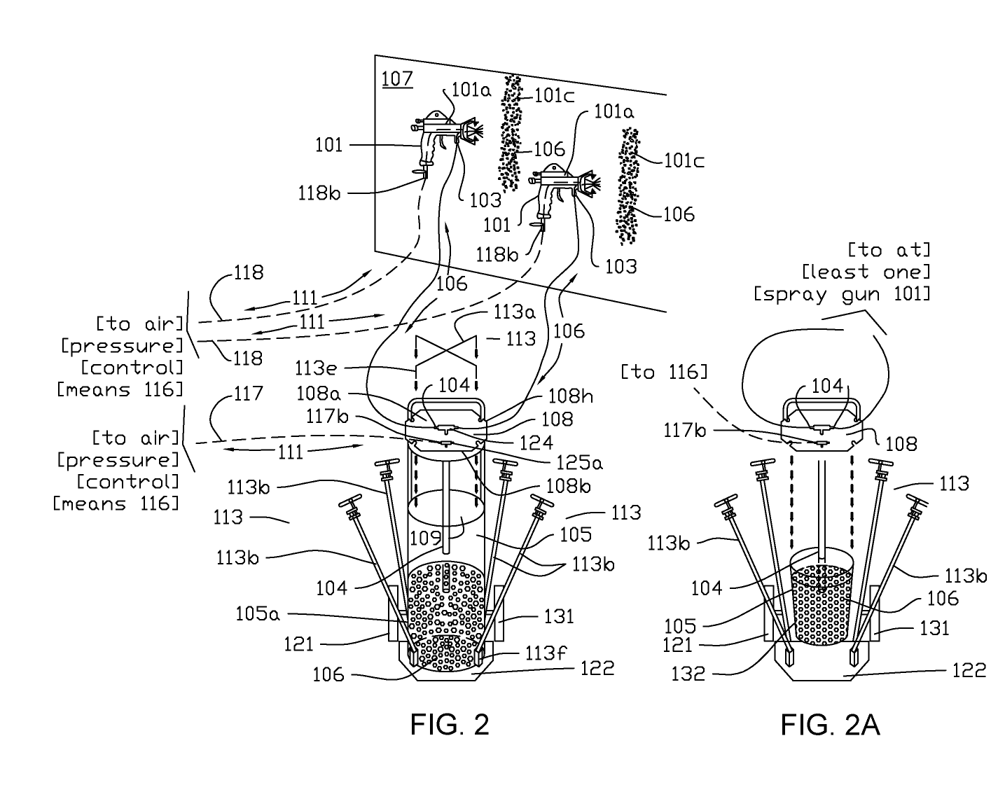

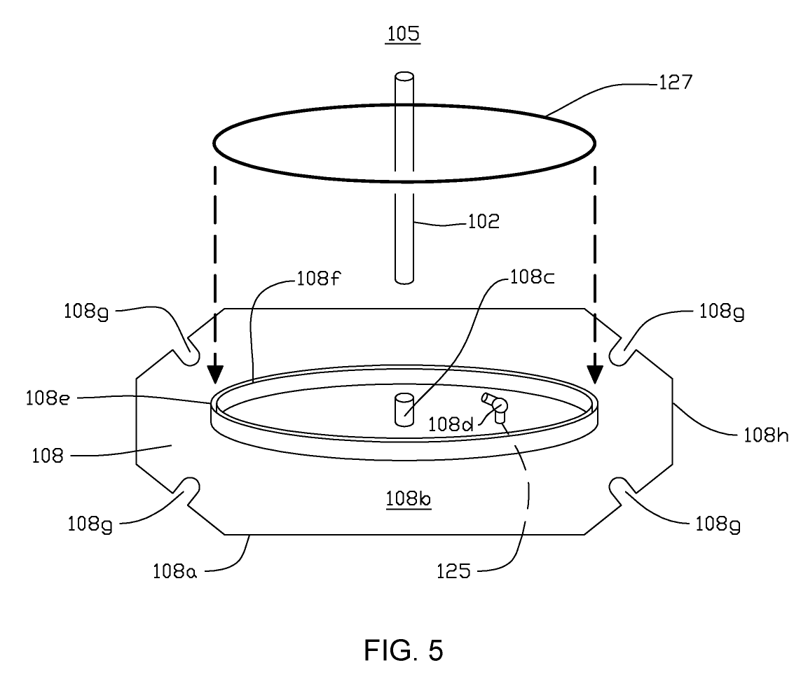

Shown in FIGS. 2-5, the removable pressure lid 108 has an outer side 108a, an opposing inner side 108b, a lid edge 108h and a plurality of lid notches 108g, located along the lid edge 108h, shown in FIG. 5. As shown in FIG. 5, the removable pressure lid 108 in an alternative embodiment further comprises a viscous nipple 108c (as pertaining to the viscous material, the coating product 106 provided by the material supply line 102 connection) for transmitting the coating product 106, air intake nipple 108d (serving as the container air hose 117 connection), a lid outer ring 108e and a lid inner ring 108f. In an alternative embodiment, the air intake nipple 108d, shown in FIG. 5, is set at an angle, proximately forty-five degrees (45°) to horizontal on the opposing inner side 108b of the removable pressure lid 108, receiving pressurized compressed air 111 from the container air hose 117 through the air supply tee 125 attached to the container air hose 117, causing the coating product 106 to stir within the sealed container 105, as the pressurized compressed air 111 impacts the coating product 106 within the sealed container 105.

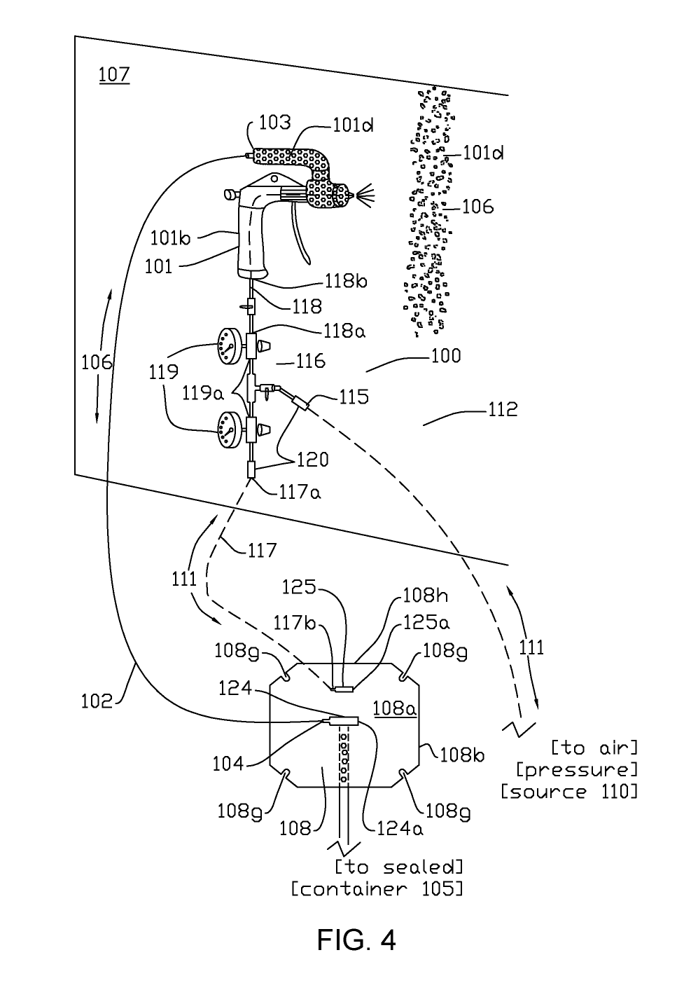

The coating product 106 includes paint 101c or a viscous surface coating 101d. The viscous surface coating 101d may be one of number of coating products 106 known in the industry, including: spackling, shotcrete, stucco, drywall mud, brown coating and other viscous protective coatings. The at least one spray gun 101 comprises an at least one paint gun 101a for applying paint 101c, shown in FIGS. 1, 2 and 3, or a texture gun 101b for applying viscous surface coating 101d, shown in FIG. 4. As shown in FIGS. 1 and 2, the at least one material supply line 102 at the opposite at least one container end 104 is operatively located within the interior compartment 109 of the sealed container 105 for receiving the coating product 106. The at least one spray gun 101, whether the at least one paint gun 101a or the texture gun 101b, may be any standard viscous material applicator gun commonly used in the industry, having the necessary nozzle capabilities and nozzle size to handle the applicable coating product 106. The at least one material supply line 102 is operationally sufficient and capable to effectively deliver coating product 106 of texture, viscosity nature as described herein, such as stucco and drywall mud.

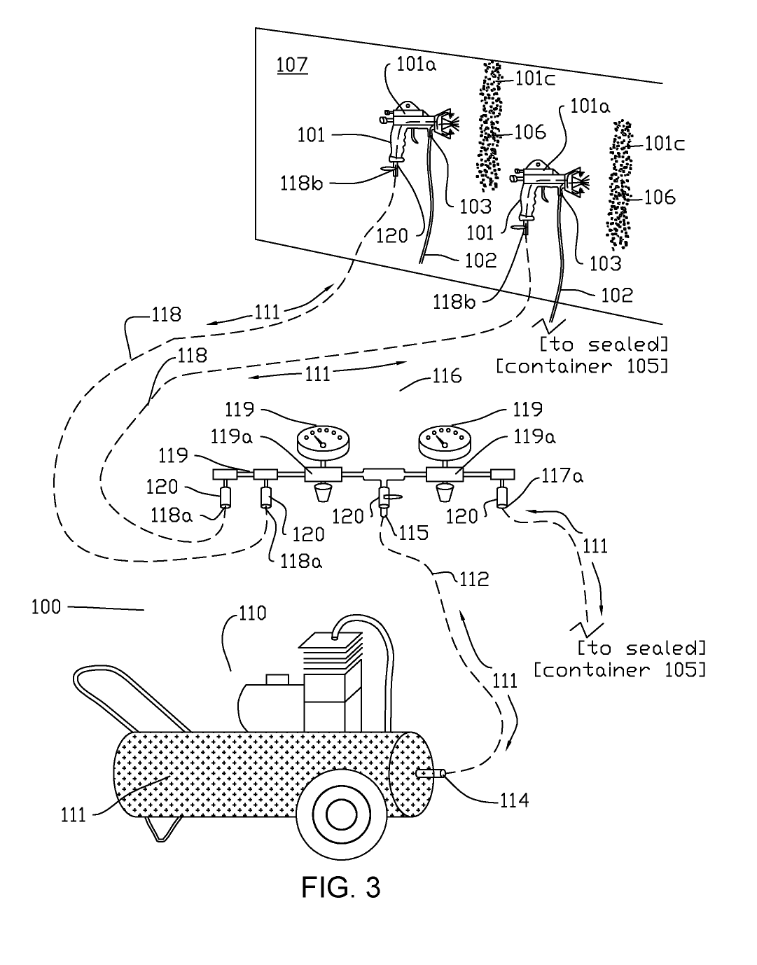

The present Invention also comprises, as shown in FIGS. 1 and 3, the air pressure system 100 comprising: an air pressure source 110, an at least one compressor air hose 112, and an air pressure control means 116. The air pressure system 100 provides the pressurized compressed air 111 to “positively” push or propel the coating product 106 through the at least one material supply line 102 and the at least one spray gun 101. The air pressure source 110 is operatively attached to the at least one compressor air hose 112 producing and delivering pressurized compressed air 111 through the at least one compressor air hose 112 from the air pressure source 110 to and through the air pressure control means 116 operatively connected to the at least one compressor air hose 112. The at least one compressor air hose 112 has a source end 114 cooperatively connecting to the air pressure source 110 and an opposing control end 115 cooperatively connecting to the air pressure control means 116, which the air pressure control means 116 operatively connects to the at least one compressor air hose 112 and an at least one spray gun air hose 118 and a container air hose 117; intermediately, or midway, between the air pressure source 110 and the at least one spray gun 101 and between the air pressure source 110 and the sealed container 105, as depicted in FIGS. 1 and 3. The air pressure control means 116 functions as a means to control and regulate, such as by pressure regulators commonly used in the industry, the pressurized compressed air 111 transmitting from the air pressure source 110 to the at least one spray gun 101 and to the sealed container 105.

As shown in FIG. 3, the air pressure control means 116 has a plurality of pressure regulators 119 and at least one gun valve end 118a and a pressure regulator end 117a on the air pressure control means 116. The plurality of pressure regulators 119 is located at the intersection of (or intersectionally located) and respectively between and operatively adjoining the opposing control end 115, the at least one gun valve end 118a and the pressure regulator end 117a. The air pressure control means 116 regulates, splits and channels the pressurized compressed air 111 from the at least one compressor air hose 112 at the opposing control end 115 through the plurality of pressure regulators 119 located, respectively on the air pressure control means 116, proximal to the pressure regulator end 117a and the at least one gun valve end 118a.

As shown in FIGS. 1-4, the container air hose 117, a portion, segment or continuation of the at least one compressor air hose 112 attaches to and receives pressurized compressed air 111 from the air pressure control means 116 at the pressure regulator end 117a (FIG. 3) and delivers the pressurized compressed air 111 at an opposing container valve end 117b (FIG. 2) and through the removable pressure lid 108 into the interior compartment 109 of the sealed container 105. The at least one spray gun air hose 118, another portion, segment or continuation of the at least on compressor air hose 112, attaches to and receives pressurized compressed air 111 from the air pressure control means 116 at the at least one gun valve end 118a (FIG. 3) and delivers the pressurized compressed air 111 to an opposing at least one spray gun air end 118b (FIG. 2) into the at least one spray gun 101 through the at least one spray gun air hose 118 into the at least one spray gun 101. Thereby, pressurized compressed air 111 is applied from the air pressure source 110 through the at least one compressor air hose 112 into the interior compartment 109 of the sealed container 105 and to the at least one spray gun 101. The sealed container 105 in FIGS. 1, 2 and 2A includes at least one of a small, lightweight removable bucket 132 or a large, durable container 105a permanently affixed to the chassis 121 described below. The removable pressure lid 108 will operationally accommodate and seal, either the large, durable container 105a or the lightweight, removable bucket 132.

The air pressure source 110 shown in FIGS. 1 and 3 includes at least one of a compressed gas cylinder or an air compressor. The pressurized compressed air 111 includes at least one of carbon dioxide gas, nitrogen gas, oxygen gas or inert gas. Any inert gas known in the industry may be utilized.

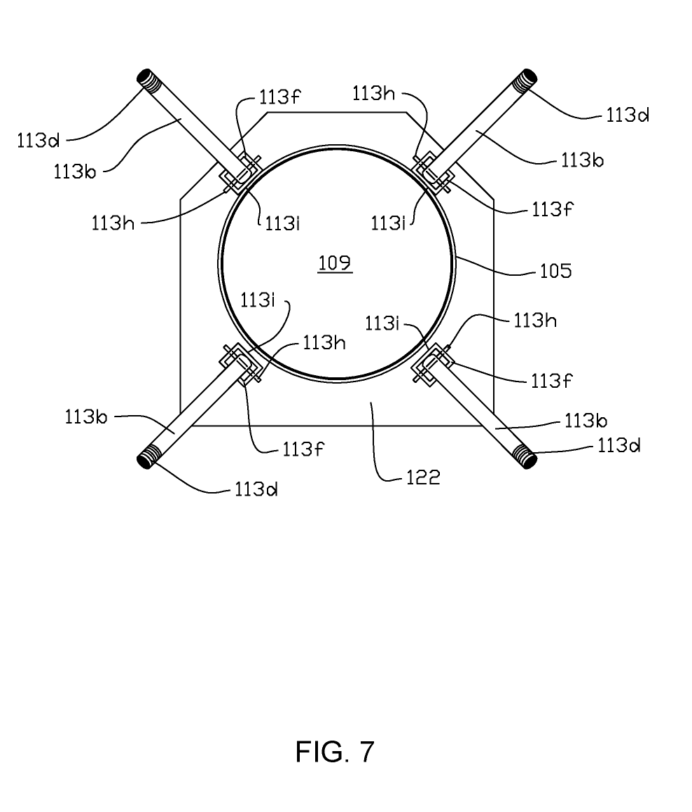

As shown in FIGS. 1, 2 and 7, one embodiment of the present Invention also comprises: a plurality of clamping means 113 attaching to the outer side 108a of the removable pressure lid 108, as a means for sealingly securing said removable pressure lid 108 to the sealed container 105; and a chassis 121 for mounting and transporting the sealed container 105, the at least one spray gun 101, the at least one material supply line 102, the container air hose 117, the at least one spray gun air hose 118 and the plurality of clamping means 113. The plurality of clamping means 113 comprises: a plurality of hollow clamp legs 113b each having a threaded screw clamp 113c located at a threaded clamping end 113d opposing an opposite base end 113i of the plurality of hollow clamp legs 113b. The threaded clamping end 113d is threaded to allow attachment of the threaded screw clamp 113c to each of the plurality of hollow clamp legs 113b. The threaded screw clamp 113c clamps down onto the removable pressure lid 108, in a manner as commonly found in screw clamps in the industry. The plurality of hollow clamp legs 113 is, respectively pivotally attached to and extending vertically from leg fittings 113f affixed to a container base 122 at the opposite base end 113i. Each of the leg fittings 113f is affixed to the container base 122 at the opposite base end 113i by commonly utilized fastening means such as a weld or bolt, and the plurality of hollow clamp legs 113b are pivotally attached to the leg fittings 113f, by a pivoting means 113h, such as a pin, bolt or other securing means allowing for a pivoting motion, as such pivoting means 113h are found in the industry. The plurality of hollow clamp legs 113b pivotally insert within the plurality of lid notches 108g along the lid edge 108h, allowing each threaded screw clamp 113c at the threaded clamping end 113d of the plurality of hollow clamp legs 113b to respectively tighten onto and secure the removable pressure lid 108. The plurality of hollow clamp legs 113b can be detached, respectively from the plurality of lid notches 108g along the lid edge 108h when the sealed container 105 needs to be opened.

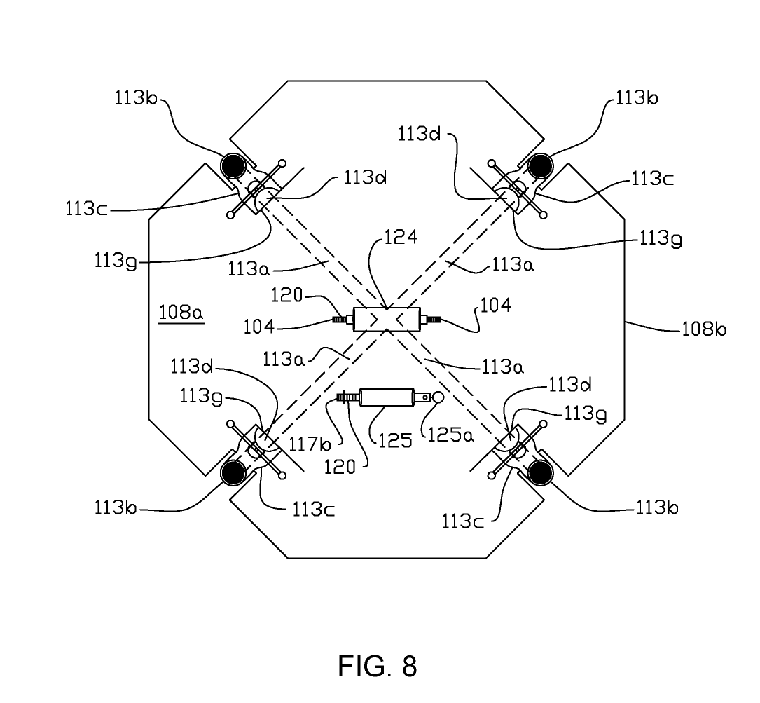

In another embodiment of the present Invention, shown in FIGS. 4 and 8, due to the necessary level of air pressure (up to 90 psi) required to move the viscous surface coating 101d through the at least one material supply line 102 (which said coating product 105 is therefore imposed under pressure on the continuous industrial flow industrial products applicator device 90), each threaded screw clamp 113c is further securely affixed onto each of the plurality of hollow clamp legs 113b at the threaded clamping end 113d by a clamp weld 113g. The clamp weld 113g is an arc weld or other weld commonly used to affix one metal component to another in the industry.

Shown in FIGS. 1, 2, 7 and 8; the plurality of clamping means 113 further comprises a safety crossbar clamp 113a, having a plurality of crossbar clamp legs 113e, securing the outer side 108a of the removable pressure lid 108 to the sealed container 105. The plurality of hollow clamp legs 113b pivotally insert within the plurality of lid notches 108g, allowing the plurality of hollow clamp legs 113b to securely and internally receive the plurality of crossbar clamp legs 113e at the respective threaded clamping end 113d to the plurality of hollow clamp legs 113b, securing the plurality of crossbar clamp legs 113e against the sealed container 105.

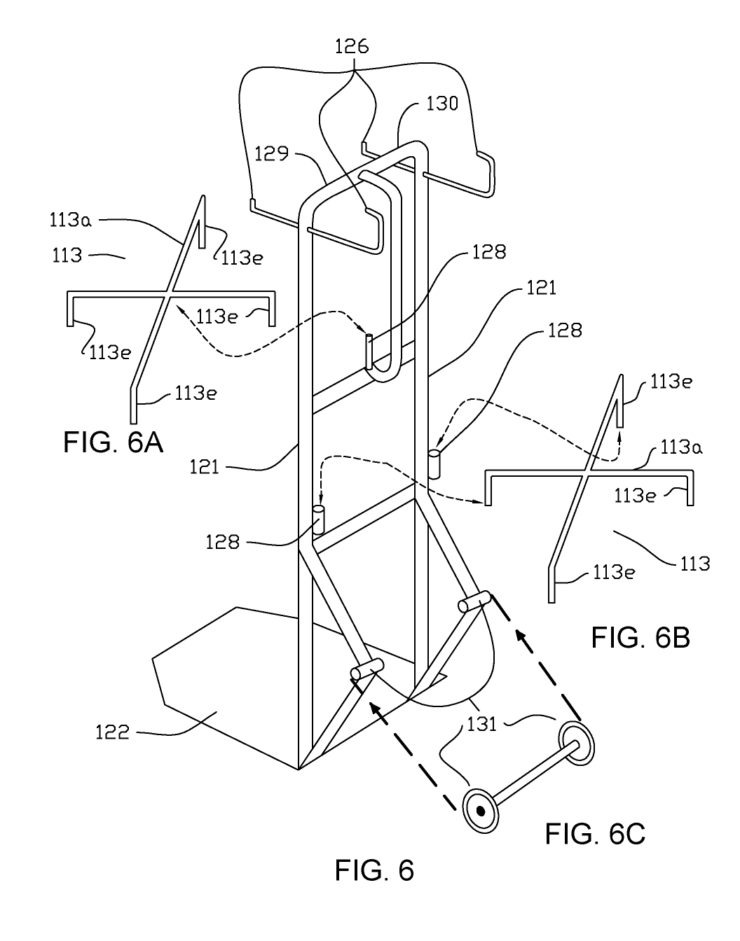

The chassis 121 shown in FIGS. 1 and 6 comprises at least one of: a dolly, truck or other wheeled, framed structure.

The at least one material supply line 102, the at least one compressor air hose 112, the container air hose 117, and the at least one spray gun air hose 118, shown in FIGS. 1-5 are individually connected to the continuous flow industrial products applicator device 90 by a plurality of connecting means 120. The plurality of connecting means 120 function as a means to secure a connection between the respective adjoining features of the continuous flow industrial products applicator device 90. The plurality of connecting means 120 include a reducer bushing, a nipple connector, a hose clamp, a locking quick disconnect, a barb coupler, or any other commonly known connecting means in the industry, to accommodate different size connecting elements.

The air pressure source 110 to the air pressure system 100, shown in FIGS. 1 and 3, provides the pressurized compressed air 111 to the sealed container 105 forcing the coating product 106 into the at least one spray gun air hose 118. The coating product 106 is propelled by the pressurized compressed air 111 through the at least one material supply line 102 into the at least one spray gun 101 and applied to the surface 107 by the continuous flow industrial products applicator device 90. The air pressure source 110 may be any one of a number of air compressors known and available in the industry, and which is understood to be powered by an electric source or an internal combustion engine.

An embodiment of the invention may comprise the plurality of pressure regulators 119 having a plurality of pressure valves 119a located within, internal to said plurality of pressure regulators 119, said plurality of pressure regulators 119 and said plurality of pressure valves 119a regulating the application of pressurized compressed air 111 by the air pressure source 110, respectively to the sealed container 105 and the at least one spray gun 101. The plurality of pressure regulators 119 having the plurality of pressure valves 119a are standard regulators commonly known and readily available in the industry.

The embodiment of the present Invention comprises a device having the unique container base 122 attached to the chassis 121, the chassis being commonly found in the industry, such as a universally standard dolly generally known.

The present Invention, as shown in FIG. 1, is directed to a spray gun device having positive pressure for applying paint 101c or the viscous surface coating 101d, a textured product (e.g., stucco or drywall mud) with a conventional (i.e. universal) spray gun rather than a spray gun combined with a hopper that uses negative pressure. As shown in FIGS. 1-4, the present Invention employs a positive air pressure system directly to the coating product 106 within the sealed container 105 that contains the coating product 106, paint or texture such as stucco, to be applied to the surface 107. The specially designed removable pressure lid 108 is provided which has the plurality of clamping means 113, having a safety crossbar clamp 113a for securing the removable pressure lid 108 to the sealed container 105 that contains the coating product 106. The removable pressure lid 108 is provided with a high pressure hose, the container air hose 117, for applying a positive pressure (minimum of 20 psi to a maximum of 90 psi) to the interior compartment 109 of the sealed container 105 which forces the coating product 106 into at least one material supply line 102, the opposite end of which is connected to at least one spray gun 101. In another embodiment of the present Invention, as shown in FIG. 1, the air pressure system operationally generates pressurized compressed air from a minimum of 20 pounds per square inch to a maximum of 90 pounds per square inch, to overcome drag or resistance of the coating product 106 on within the at least one material supply line 102 and in the sealed container 105.

The at least one spray gun 101 is any of a number of applicable spray guns found and known in the industry. In other embodiments, conventional regulators and valves found in the industry may provide as necessary additional regulation of the pressurized compressed air 111 or coating product 106 shown in FIG. 1.

Several advantages exist with the present Invention over the prior art; for examples: the elimination, as shown in FIGS. 1 and 2, of the need to constantly refill a spray gun hopper with the coating product 106, and the elimination of any “setting” (drying) of coating product 106, particularly the viscous surface coating 101d such as stucco, in the at least one spray gun 101, in this case in the texture gun 101b, during periods of non-use. In alternative embodiments, shown in FIGS. 2 and 2A, the sealed container 105 includes a small, lightweight removable bucket 132, for example, a five gallon bucket; or the large, durable container 105a permanently affixed to the chassis 121. The sealed container 105, shown in FIG. 2 may further comprise in alternative embodiments the large, durable container 105a, permanently affixed to the chassis 121, holding 100 milliliters or greater of coating product 106, in order to improve the efficiency of the operation by having a larger container, avoiding frequent refilling and more labor and time.

Once the small lightweight, removable bucket 132 in FIG. 2A is emptied of coating product 106 during the spray application process by the continuous flow industrial products application device 90, the removable pressure lid 108 is removed and then reconnected to a newly installed small lightweight, removable bucket 132 containing coating product 106 within the sealed container 105 so that spray application can be resumed. The continuous flow industrial products applicator device 90 is made of differing durable products, such as metal for the chassis and rubber for the hoses, as set forth below.

In FIGS. 1 and 3, the air pressure system 100 of this continuous flow industrial products applicator device 90 may provide in alternative embodiments any number of air pressure sources 110, in a positive manner, as found in the industry to provide pressurized compressed air 111 to coating applicator devices such as a common air compressor. In the present Invention the air pressure source 110 provides the positive, pressurized compressed air 111 to the sealed container 105 forcing the coating product 106 into at least one material supply line 102 (a hose). By this embodiment, the coating product 106 is applied through the at least one spray gun 101 to the surface 107 by the continuous flow industrial products applicator device 90. Application of a positive air pressure to the paint 101c or viscous surface coating 101d, coating product 106, in the sealed container 105, then forces the coating product 106 into a conventional at least one spray gun 101 and negates the need for a spray gun hopper operating under a negative, vacuum pressure. The present Invention has the safety crossbar clamp 113a, shown in FIGS. 1 and 2, mounted in such a manner that the lightweight removable bucket 132 (or removable pressure lid 108 which is holding the coating product 106 under pressure), preventing leakage and the removable pressure lid 108 remains firm and tight on the lightweight, removable bucket 132 at all degrees of psi, up to 90+psi. The multiple clamps of the present Invention, contained in the plurality of clamping means 113, including the safety crossbar clamp 113a, provide for a safe and proper use of this Invention, the continuous flow industrial products applicator device 90.

One purpose of an embodiment of the Invention is to create a simple device that could supply materials, coating products 106, such as paint 101c and viscous surface coating 101d; i.e., stucco, drywall, and brown coating; to any at least one spray gun 101 using a positive air pressure, as shown in FIG. 1. The at least one spray gun 101 can be any of the spray guns utilized and known in this industry, generally, such as those having a ball valve regulating air pressure in the spray gun.

This Invention can be used in a multitude of environments including but not limited to commercial, private, and construction projects that require paint or textures to be applied to a particular surface.

Shown in FIGS. 1, 2, 4 and 5, the removable pressure lid 108 has a safety crossbar clamp 113a. The chassis 121, shown in FIGS. 1 and 6, has the container base 122 and a pressure regulator bar 130, and is adapted with hose hangers 126 adjacent and proximal to a dolly handle 129 in an alternative embodiment.

An advantage of the present Invention is that it does not need a hopper on the texture gun 101b or a “can/jar” (a jet system that pulls material out via a negative air, vacuum) on the at least one paint gun 101a, shown in FIGS. 1, 2 AND 3. Rather, the air pressure system 100 of the present Invention forces the coating product 106 material to the at least one spray gun 101 (that is, any applicator gun found and known in this industry) with positive air pressure, the pressurized compressed air 111. The present Invention air pressure system 100, or mechanism, of the continuous flow industrial products applicator device 90 is easier for one man to use than a hopper device or apparatus common in the industry. The present Invention allows continuous spray without an operator having to stop and refill the hopper. In turn, this time factor increases operator productivity, time saving money.

The use of hoses and supply lines in the manner of the present Invention allows the operator to apply coating product 106, as shown in FIGS. 1 and 4, farther from the sealed container 105 when using texture product, such as stucco and drywall product, on a surface 107; with paint product, shown in FIG. 2, the application distance increases in length, with a single at least one spray gun 101 being used, or the operator may half that distance with duel, multiple (such as two) at least one spray guns 101 being used at the same time. Whereas, with the hopper devices of prior art, the operator has to continually return to a source for more coating product 106 material or pack a product container every few feet, commonly within every 5 feet of spray application. The operator of the present Invention does not need to stop spraying and using the continuous flow industrial products applicator device 90 until the sealed container 105 is empty. As well, being under pressure in a sealed container 105, the present Invention empties the coating product 106 from the sealed container 105 with no waste.

The hopper in other related art is heavy, weighing between 15 and 20 pounds, when full of coating product 106. The lightweight removable bucket 132, shown in FIG. 1A, of one embodiment of the present Invention with its air pressure system 100 when connected to the texture gun 101b, in FIG. 4, can weigh less than five pounds. The operator is able to work longer using the embodiment of the present Invention without fatigue. This present Invention allows the operator to spray coating product 106, shown in FIGS. 1-4 in any direction/angle and into hard-to-access areas with ease.

The coating product 106 being used by the present Invention depicted in FIGS. 1-2 does not set up or harden while waiting spray application. The air pressure system 100 of the present Invention allows the coating product 106 to sit in the at least on material supply line 102 and at least one spray gun 101 during a break from application without hardening or setting up. With the requirement of a hopper in prior art, the coating product 106, in particular the “brown coating” type of a viscous surface coating 101d (which is an adhesive product known in the art), will harden in about 15 minutes if left to set, causing damage to the texture gun 101b and/or other parts of the continuous flow industrial products applicator device 90. The viscous surface coating 101d may stand for up to 24 hours in the at least one material supply line 102 and texture gun 101b of the continuous flow industrial products applicator device 90, and still be in a pliable, workable condition, “as is,” without hardening. The viscous surface coating 101d thereby remains in the same condition as it would if resealed in the sealed container 105 for future use at a later date. There is virtually no loss or waste of coating product 106 with this present Invention.

To switch from one sealed container 105, as when emptied by the operator during use, such as a lightweight removable bucket 132, to the next with the present Invention shown in FIGS. 1, 1A, 2, 2A and 8, using the same coating product 106; the operator turns off air pressure source 110 checking the plurality of pressure regulators 119 for a safe pressure reading to disconnect the removable pressure lid 108, pulls the safety crossbar clamp 113a, loosens the plurality of hollow clamp legs 113b by unscrewing the threaded screw clamps 113c, removes the plurality of clamping means 113, uses the plurality of connective means 120 as quick disconnects to the removable pressure lid 108, and adds new coating product 106, without any clean-up and; then replaces the removable pressure lid 108 using the plurality of leg clamps 113b and the safety crossbar clamp 113a. Clean-up is only required if the operator is changing coating product 106 type or when a coating project is finished.

The Invention in another embodiment is easily adapted from a “dual hose” application for spraying paint shown in FIGS. 1, 2 and 3 to a “single hose” application for spraying texture, as shown in FIG. 4. In such embodiment, shown in FIGS. 1, 2, 4 and 5; a material supply line tee 124 located on the removable pressure lid 108 is operatively connecting to the at least one material supply line 102 at the opposite at least one container end 104, and an air supply tee 125 located on the removable pressure lid 108 is operatively connecting to the container air hose 117 at the opposing container valve end 117b and has a pressure release pop-off valve 125a opposite the opposing container valve end 117b. In the single spray gun embodiment, shown in FIG. 4, the material supply line tee 124 further comprises a tee plug 124a, inserted into the opposite at least one container end 104 in FIGS. 2A, 3 and 4, the material supply line tee 124 is not being used for more than one of the at least one spray gun 101.

In another embodiment, the pressure release pop-off valve 125a, depicted in FIGS. 2, 4 and 8, allows the operator to operate the continuous flow industrial products applicator device 90 without over-pressurizing the sealed container 105, the pressure release pop-off valve 125a yielding to and releasing excessive air pressure. The operator may adjust the pressure release level governing the pressure release pop-off valve 125a. The removable pressure lid 108 may have in an alternative embodiment, shown in FIG. 5, a gasket lining 127 located between the lid outer ring 108e and the lid inner ring 108f, operationally and alternatively accommodating and sealing the large, durable container 125a, as well as the lightweight, removable bucket 132, in order to seal the sealed container 105 from air pressure loss.

The chassis 121 in FIGS. 1, 6 and 6A-6C further comprises hose hangers 126, two adjustable wheels and wheel mounts 131, a pressure regular bar 130 for mounting the plurality of pressure regulators 119, the dolly handle 129 referenced above and a safety crossbar holder 128. As shown in FIGS. 1, 6 and 6A-6C, a rack, or hose hangers 126 proximal to the dolly handle 129 of the chassis 121 may hold, in one embodiment, the removable pressure lid 108, temporarily when off the sealed container 105 and a pressure regulator bar 130, for mounting the plurality of pressure regulators 119, thus making it easy for the operator to read and make adjustments as needed with no interference by the remaining elements of the continuous flow industrial products applicator 90. The hose hangers 126 in another embodiment, they may be used to hang the various continuous flow industrial products applicator device 90 hoses and lines when the present Invention is not in use, making mobility of the chassis 121 safer and more compact for storage. Shown in FIGS. 6 and 6A-6C, two adjustable wheels and wheel mounts 131 are included in an alternative embodiment of the chassis 121, constituting a dolly, to the present Invention. This embodiment allows the operator to adjust wheels of the adjustable wheels and wheel mounts 131 for use with any size of scaffolding, making movement of the continuous flow industrial products applicator device 90 easy and safe for the operator and co-workers. This adds stability to the present Invention while in use and when elevated into scaffolding.

The invention has the ability to allow the operator to work faster than with the traditional spray applicator devices known in the industry, and alleviates the constant stopping by the operator to reload a hopper for a texture gun or a smaller can/jar for a paint gun in other art. The issue of equipment weight for the operator is lessened by use in another embodiment, of the chassis 121 for mobility with the use of viscous surface coatings 101d, and of safety on scaffolding by having, as shown in FIG. 6, the adjustable wheels and wheel mounts 131 with a dolly. The continuous flow industrial products applicator device 90 is safer when in use by providing for properly storing any hose(s) or other parts of the Invention (when not in use) on the hose hangers 126 and a safety crossbar holder 128 attached near the dolly handle 129 of the chassis 121 and finally when using the duel hose system, provided by the at least one spray gun 101. This issue of weight applies to the lightweight, removable bucket 132 use (such as a 5 gallon bucket). A heavy duty, durable container (such as a 10 gallon container) is generally too large and heavy for scaffold use, but is usable with a man lift or basket, in traditional spray applicators. The sealed container 105, chassis 121, and the elements to the plurality of clamping means 113 are made of hardened, metallic material, such as steel, to withstand the internal pressure necessary to move and propel the texture coating product 106 and prevent “blow off” of the removable pressure lid 108, as shown in FIGS. 1, 2, and 4-8. The wheels to the chassis 121, and container air hose 117, at least one compressor air hose 112 and at least one material supply line 102 are made of flexible resilient material, such as rubber.

Having thus described in detail a preferred selection of embodiments of the present Invention, it is to be appreciated, and will be apparent to those skilled in the art, that many physical changes could be made in the device without altering the invention, or the concepts and principles embodied therein. Unless otherwise specifically stated, the terms and expressions have been used herein as terms of description and not terms of limitation, and are not intended to exclude any equivalents of features shown and described or portions thereof. Various changes can, of course, be made to the preferred embodiment without departing from the spirit and scope of the present invention. The present invention device, therefore, should not be restricted, except in the below claims and their equivalents.

I claim:

1. A continuous flow industrial products applicator device, said device comprising:
(a) an at least one spray gun;
(b) an at least one material supply line having at least one gun end cooperatively connected to the at least one spray gun and an opposite at least one container end cooperatively connected to a sealed container;
(c) the sealed container having a removable pressure lid, and defining an interior compartment containing a coating product to be applied to a surface by the at least one spray gun;
(d) the at least one material supply line being operatively located within the interior compartment for receiving the coating product;
(e) the removable pressure lid having an outer side, an opposing inner side, a lid edge and a plurality of lid notches, located along the lid edge;
(0 an air pressure system comprising: an air pressure source, an at least one compressor air hose, and an air pressure control means;
(g) the air pressure source producing a pressurized compressed air and operatively attaching to the at least one compressor air hose and delivering the pressurized compressed air through the at least one compressor air hose from the air pressure source to and through the air pressure control means operatively connected to the at least one compressor air hose;
(h) the at least one compressor air hose having a source end cooperatively connecting to the air pressure source and an opposing control end cooperatively connecting to an air pressure control means, which air pressure control means operatively connects to the at least one compressor air hose, an at least one spray gun air hose and a container air hose; the air pressure control mean being intermediately between the air pressure source and the at least one spray gun, and between the air pressure source and the sealed container;
(i) the air pressure control means comprising of an at least one gun valve end and a pressure regulator end and a plurality of pressure regulators intersectionally located between and operatively adjoining the opposing control end, the at least one gun valve end and the pressure regulator end;
the air pressure control means regulating, splitting and channeling the pressurized compressed air from the at least one compressor air hose at the opposing control end through the respective plurality of pressure regulators located on the air pressure control means between the at least one gun valve end and the pressure regulator end;
(j) the container air hose attaching to and receiving pressurized compressed air from the air pressure control means at the pressure regulator end and delivering the pressurized compressed air at an opposing container valve end to the container air hose and through the removable pressure lid into the interior compartment of the sealed container;
(k) the at least one spray gun air hose attaching to and receiving pressurized compressed air from the air pressure control means at the at least one gun valve regulator end and delivering the pressurized compressed air to an opposing at least one spray gun air end through the at least one spray gun air hose into the at least one spray gun;
(l) a plurality of clamping means attaching to the outer side of the removable pressure lid for sealingly securing said removable pressure lid to the sealed container;
(m) a chassis for mounting and transporting the sealed container, the at least one spray gun, the at least one material supply line, the container air hose, the at least one spray gun air hose and the plurality of clamping means; and
(n) whereby the coating product is propelled through the at least one material supply line into the at least one spray gun and applied to the surface by the continuous flow industrial products applicator device.

2. The continuous flow industrial products applicator device of claim 1 further comprising: the plurality of pressure regulators having a plurality of pressure valves located within the plurality of pressure regulators, regulating the application of the pressurized compressed air from the air pressure source to the sealed container and the at least one spray gun.

3. The continuous flow industrial products applicator device of claim 1, wherein the coating product includes: paint or a viscous surface coating.

4. The coating product of claim 3, wherein the viscous surface coating includes: spackling, shotcrete, stucco, drywall mud, brown coating or other viscous protective coating.

5. The continuous flow industrial products applicator device of claim 1, wherein the air pressure source includes at least one of a compressed gas cylinder or an air compressor.

6. The continuous flow industrial products applicator device of claim 1, wherein the pressurized compressed air includes at least one of carbon dioxide gas, nitrogen gas, oxygen gas or inert gas.

7. The continuous flow industrial products applicator device of claim 1, wherein the sealed container includes: a small, lightweight, removable bucket or a large, durable container permanently affixed to the chassis.

8. The sealed container of claim 7 further comprising: the large, durable container holding 100 milliliters or greater of coating product.

9. The continuous flow industrial products applicator device of claim 1, wherein the plurality of clamping means comprises:
(a) a plurality of hollow clamp legs each having a threaded screw clamp located at a threaded clamping end opposing an opposite base end of the plurality of hollow clamp legs, whereby the plurality of hollow clamp legs is, respectively, pivotally attaching to and extending vertically from leg fittings at the opposite base end affixed to a container base;
(b) the plurality of hollow clamp legs being pivotally attached respectively to the leg fittings by a pivoting means;
(c) the threaded clamping end allowing attachment of the threaded screw clamp to each of the plurality of hollow clamp legs;
(d) the plurality of hollow clamp legs pivotally inserting within the plurality of lid notches, allowing the threaded screw clamp at the threaded clamping end of the respective plurality of clamp legs to tighten onto and secure the removable pressure lid;
(e) each threaded screw clamp further securely affixing onto each of the plurality of hollow clamp legs at the threaded clamping end by a clamp weld;
(f) a safety crossbar clamp having a plurality of crossbar clamp legs securing the outer side of the removable pressure lid to the sealed container; and
(g) whereby the plurality of hollow clamp legs securely and internally receive the plurality of crossbar clamp legs to the safety crossbar clamp at the respective threaded clamping end of the plurality of hollow clamp legs, securing the plurality of crossbar clamp legs against the sealed container.

10. The continuous flow industrial products applicator device of claim 1, wherein the chassis comprises at least one of: a dolly, truck, or other wheeled, framed structure.

11. The continuous flow industrial products applicator device of claim 1, wherein the material supply line, the compressed air hose, the container air hose, the spray gun air hose are individually connected to the containers flow industrial products applicator device by a plurality of connecting means.

12. The continuous flow industrial products applicator device of claim 1, wherein the plurality of connecting means include at least one of a reducer bushing, a nipple connector, a hose clamp, a locking quick disconnect, a barb coupler, or other connecting element.

13. The continuous flow industrial products applicator device of claim 1, wherein the at least one spray gun comprises: at least one paint gun or a texture gun.

14. The continuous flow industrial products applicator device of claim 1, further comprising: a material supply line tee located on the removable pressure lid and operatively connecting to the at least one material supply line at the opposite at least one container end, and an air supply tee located on the removable pressure lid and operatively connecting to the container air hose at the opposing container valve end and a pressure release pop-off valve opposite the opposing container valve on the air supply tee.

15. The material supply line tee of claim 14, further comprising: a tee plug.

16. The continuous flow industrial products applicator device of claim 1, wherein the removable pressure lid further comprises: a viscous nipple, an air intake nipple, a lid outer ring and a lid inner ring.

17. The continuous flow industrial products applicator device of claim 1, wherein the removable pressure lid comprises a gasket lining between the lid outer ring and the lid inner ring sealing the sealed container, allowing the removable pressure lid to operationally and alternatively accommodate and seal the large, durable container, as well as the lightweight, removable bucket.

18. The continuous flow industrial products applicator device of claim 1, wherein the chassis further comprises: hose hangers, two adjustable wheels and wheel mounts, a pressure regulator bar for mounting the plurality of pressure regulators, a dolly handle and a safety crossbar holder.

19. The continuous flow industrial products applicator device of claim 1, wherein the clamping means is made of steel.

20. The continuous flow industrial products applicator device of claim 1, wherein the air pressure system operationally generating pressurized compressed air from a minimum of 20 pounds per square inch to a maximum of 90 pounds per square inch.

21. The continuous flow industrial products applicator device of claim 1, wherein the air intake nipple is setting proximately 45° to horizontal on the opposing inner side of the removable pressure lid, receiving pressurized compressed air from the container air hose through the air supply tee attached to the container air hose, and causing the coating product to stir within the sealed container.

22. The continuous flow industrial products applicator device of claim 1, wherein the hose hangers proximal to the dolly handle of the chassis hold the removable pressure lid temporarily and the pressure regulator bar for mounting the plurality of pressure regulators.
